(19) United States
(12) Patent Application Publication
(10) Pub. No.: US 2026/0259817 A1
(43) Pub. Date: Sep. 3, 2026

(54) TESTING, TRAINING OR VALIDATING REASONING MODELS

(71) Applicant: Microsoft Technology Licensing, LLC, Redmond, WA (US)

(72) Inventors: Fabian Maximilian FALCK, Oxford (GB); Kshitij DUBEY, Bengaluru (IN); Atharva PANDEY, Bengaluru (IN); Xinnuo XU, Cambridge (GB); Risa UENO, Cambridge (GB); Aditya Vithal NORI, Cambridge (GB); Amit SHARMA, Bengaluru (IN); Rahul SHARMA, Bengaluru (IN); Javier GONZÁLEZ HERNÁNDEZ, Cambridge (GB); Rachel Shannon LAWRENCE, Cambridge (GB)

(21) Appl. No.: 19/096,501

(22) Filed: Mar. 31, 2025

(30) Foreign Application Priority Data
Feb. 28, 2025 (IN) 202511018088

(51) Int. Cl. G06F 11/3604

(52) U.S. Cl. CPC G06F 11/3608

(57) ABSTRACT

In one aspect herein, a symbolic representation is generated from a natural language reasoning problem, which can then be mutated to produce a symbolic problem variant and a natural language problem variant. This data synthesis techniques provides reasoning data that in some example applications is used to test a model's reasoning capabilities. Example applications include comparing model-generated answers against programmatically derived ground truth to distinguish genuine reasoning from memorized patterns. As another example, certain training applications repeatedly expose a model to newly synthesized data for iterative refinement.

The present disclosure pertains to artificial intelligence (AI) and machine learning (ML), and more specifically to tools and techniques for training, testing or validating reasoning models.

### BACKGROUND

Reasoning models, including OpenAI o1 and o3-mini as well as DeepSeek, are examples of recently developed large language models trained with reinforcement learning to perform complex reasoning. They engage in an internal chain of thought prior to providing an answer, which allows them to address multi-step planning, coding, or scientific analyses in a more structured manner. By simulating a progression of intermediate inference steps, these models can tackle intricate problems and demonstrate agentic capabilities. In comparison to conventional large-scale models, these systems do more than accumulate increasingly vast training sets. However, they can still memorize patterns from benchmark tests present in their data. Evidence shows model performance can deteriorate simply by inserting additional or irrelevant information in a reasoning problem, hinting that certain outputs arise from statistical recall rather than a genuine reasoning capacity.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

In one aspect herein, a symbolic representation is generated from a reasoning problem, which can then be mutated to produce an “intermediate” symbolic problem variant (a programmatic or executable encoding of the reasoning problem in terms of defined variables and dependencies) and a reasoning problem variant (e.g., by mutating the intermediate symbolic representation and transforming back to a modality of the original reasoning problem). This data synthesis techniques provides reasoning data that in some example applications is used to test a model's reasoning capabilities. Example applications include comparing model-generated answers against programmatically derived ground truth to distinguish genuine reasoning from memorized patterns. As another example, certain training applications repeatedly expose a model to newly synthesized data for iterative refinement.

### BRIEF DESCRIPTION OF FIGURES

Example embodiments will now be described with reference to the accompanying figures, in which:

FIG. 1 depicts a pipeline for generating symbolic problem variants from natural language reasoning problems.

FIG. 2 illustrates a flow for converting inputs into an executable representation that provides ground truth for training, testing or validation.

FIG. 3 shows an example for generating and applying mutated reasoning problems.

FIG. 4 shows a flow chart for a method of generating reasoning problem variants.

FIG. 5 shows a schematic block diagram of a computing system architecture that supports pipeline operations in some examples.

### DETAILED DESCRIPTION

A significant technical challenge in building reasoning models lies in rigorously testing the scope and reliability of their reasoning. On the surface, an advanced language model might appear proficient at problem solving; however, evaluating whether it truly reasons or merely recycles patterns from existing data remains non-trivial. Benchmark sets often end up in the training corpus, potentially inflating measured performance. Consequently, designing truly unseen, context-rich tasks becomes imperative to identify genuine reasoning competence.

A key aspect herein is the capacity to automatically generate an arbitrary number of reasoning tests. A data synthesis pipeline is provided capable of large scale, automated “reasoning data” synthesis. This offers a means to scale beyond fixed benchmarks, ensuring that a model cannot fall back on pattern matching from its training distribution. By systematically synthesizing fresh problem statements and logic modifications, it becomes practical to explore a broader range of test parameters that target specific weaknesses of a reasoning system, separating authentic reasoning potential from mere memorized statistical patterns.

A core use case of conducting thorough validation on reasoning models is to leverage the outcomes for model improvement. For instance, one or more iterations of re-architecting, training (e.g. training from scratch, retraining, or fine-tuning etc.) might be guided by performance data gathered from these dynamically created tests. Some implementations provide an automated loop in which newly surfaced gaps in logical reasoning are addressed by synthesizing targeted training data. By iterating in this manner, improvements in model accuracy and reliability on complex tasks are achieved.

In some use cases, a trained reasoning model is used for declarative applications such as classification or regression tasks. In other use cases, a reasoning model is used for generative tasks, leveraging an ability of the reasoning model to synthesize new data points. Applications include for example image classification or extraction of meaningful information from images, text classification, or analyzing audio signals to distinguish speech from non-speech. Similar modeling approaches can be extended to sensor data, enabling tasks such as automated measurement, machine control, or medical diagnostics. In all these scenarios, the model's refined reasoning ability can yield significant accuracy improvements and robust performance by facilitating more consistent intermediate inferences.

Some embodiments systematically transform existing benchmarks to better evaluate logical reasoning. This effort aims to generate new, unseen tasks that cannot be resolved by mere repetition of training data. To address this gap, a hierarchical framework has been populated with levels of increasing difficulty. By examining how models behave when faced with progressively more intricate modifications, the framework distinguishes true analytic capacity from statistical recall.

A central aspect is the automated synthesis of problem variations. A model's ability to handle tasks that have been mutated in a controlled way acts as evidence of robust reasoning skills. For instance, if one takes an original math question from a well-established dataset, then systematically alters the variables or introduces a new conditional statement, the model can be tested again. If the answers degrade significantly, the possibility arises that the model relies on memorization rather than analytic problem-solving.

A symbolic transformation pipeline is described that converts an original problem, such as a math or code task (e.g. from a known reasoning benchmark), into an intermediate representation that can then be mutated. This stage encompasses symbolic representation such as a code snippet, knowledge graph or computational graph or any set of symbolic expressions that encapsulate relevant variables and their dependencies. An important objective is the automated generation of one or more new variants of the same underlying reasoning problem, preserving essential logical dependencies while preventing direct memorization. An executable script or graph-based structure provides an easy means of recalculating each ground truth response (the “correct” answer to a mutated problem) whenever a variable or relation is altered. In doing so, a wide variety of novel tasks can be systematically and precisely created, along with their associated ground truth for training, validation, testing etc. The ground truth response is programmatically obtained by executing the symbolic variant. The mutated problem is transformed back to natural language suitable for inputting to a reasoning model.

In some embodiments, to enable the mutation, a symbolic representation is first transformed into a directed computational graph where each node represents a variable or a function of prior nodes. The root nodes correspond to externally provided constants or input parameters, while dependent nodes encode arithmetic or logical transformations. Once this structure is defined, an automatic procedure can apply mutations e.g., to modify root values, rename identifiers, or insert fresh relations in the graph. The mutated graph remains executable, enabling a new ground-truth solution to be computed with minimal human intervention. A language model is thus tested on questions regenerated in a natural language form derived from the modified graph. This process ensures that the core logic is preserved, yet superficial details have changed in a manner that discourages memorized answers.

In one embodiment, the symbolic representation is transformed into a computational graph comprising a first node representing a first variable, a second node representing a second variable, and an edge reflecting a dependency between the first variable and the second variable. Generating a mutation then involves modifying this computational graph to obtain the symbolic problem variant. When translated back to natural language, these changes preserve the reasoning path yet disrupt any reliance on memorized patterns.

Another important aspect of the pipeline is its ability to apply different mutation types systematically. A typical example is a numeric resampling step, which replaces original values with newly sampled ones while preserving the underlying dependencies. Another illustrative example is an irrelevant-information step that appends extraneous descriptions or variables to the graph without affecting the final answer. Additional transformations can integrate a revised logic, sometimes contradicting or updating an earlier statement so that the model must incorporate a new predicate or condition on the spot. In the code-based domain, these symbolic changes might translate to new lines or modified operators in a script, eventually generating a question that is the textual counterpart of the changed graph. Usefully, a final numeric or Boolean result can be derived by running the updated code, confirming that the underlying logic remains valid or intentionally shifted. Through automatic application of these mutations, the pipeline can produce arbitrarily many customized tasks across multiple reasoning domains.

In addition to enabling thorough validation, an executable variant of each problem can be used to synthesize one or more training datasets for decoupled model refinement. Because values and conditions in the symbolic representation can be altered automatically, many new activity-solution pairs are produced without human oversight, each preserving core logical dependencies. This includes generating natural language text questions linked with definitive solutions, so a model may train on reasoning examples at scale.

An intermediate symbolic form has proven helpful in implementing such benchmark transformations. By converting an original problem into code or a directed graph of dependencies, developers can reliably introduce changes, re-compute the correct solution, and then emit a newly modified natural language form of the original task. This approach yields many variants of the same core problem, each requiring the same logical steps yet with new details that discourage memorized answers. Systematic generation of synthetic training data can then be facilitated through these symbolic transformations.

A layered approach is used to assess reasoning in some embodiments. One or more simpler tasks measure how the model performs on existing, possibly memorized items, whereas a deeper tier introduces new values in the problem statements and extraneous information. Some of the highest-level tasks demand revising or contradicting prior statements, creating scenarios akin to counterfactuals. This final tier highlights causal inference requirements by quantifying the likelihood of necessity or sufficiency for a specified cause, revealing the model's capacity to adapt its reasoning under altered assumptions.

A key motivation for these transformations lies in ensuring that test sets remain truly novel. Conventional benchmarks risk contamination if they appear in pre-training data. By creating on-demand variants, one can better expose a model's overreliance on rote memorization. The pipeline systematically re-expresses the original tasks so that the essential reasoning structure remains, but extraneous or altered details prevent direct memorized retrieval.

Beyond evaluation, these variant tasks can be fed back into an extended training pipeline. A model can benefit from additional rounds of fine-tuning using the newly generated problems, especially at the more advanced levels of difficulty. This tactic strengthens a model's capacity to handle fresh or contradictory statements. In practice, the same pipeline used to create adjustments for testing can supply curated synthetic data for further refinement of the model.

In some use cases, synthetic problems generated using the described tools and techniques are used to guide further training of the underlying models. Standard fine-tuning interfaces, such as those offered by certain AI platforms, already exist to incorporate custom data. With the pipeline's ability to produce large numbers of problems for math, code-based tasks, and causal inference queries, it becomes possible to feed curated examples back into the model's learning process, thereby boosting its accuracy on tasks requiring logical thought rather than memorized patterns. Other training methodologies can be applied using synthetic problem-ground truth pairs generated using the present techniques.

The described pipeline provides the foundation for a “dynamic test suite”. Instead of relying on a static collection, the pipeline can produce fresh variants whenever a new model is released or a new domain is explored. This approach keeps pace with rapidly evolving models and user challenges. It also offers a structured route to bridging identified gaps in a model's capabilities, as developers can home in on specific difficulties, generate additional problem sets, and track improvements over time.

One example is code verification tasks that require tracking loop invariants or analyzing function outputs. Simple rearrangements, new conditional logic, or extra variables can quickly reveal whether a model's reasoning remains sound, or if it was simply memorizing solutions from training data. Similarly, in mathematics or causal reasoning domains, careful modifications make standard benchmarks significantly more challenging, thus providing crucial insights into a model's capability to adapt to novel inputs.

The described techniques yield a practical improvement in process and tooling used to measure the quality of AI models (with respect to reasoning ability), through systematically and programmatically assessing whether any given model (e.g. large language mode, small language model, multimodal model etc.) is performing reasoning.

Two important aspects which can be used alone or in combination are: (1) the ability to create a dynamic rather than static test suite on-demand for a wide variety of reasoning tasks, and (2) a principled definition and measurement of three different levels of reasoning in language models. The former is a technical improvement because, as discussed, static test suites do not appropriately account for the fact that language models are frequently trained on the test set, and so their evaluation results are not reliable as a measure of reasoning. Creating dynamic test suites for reasoning using conventional approaches require significantly more human effort compared with the present approach. The latter is also a technical improvement because it provides a new way to define and measure reasoning in language models. It expands the pipeline's ability to test reasoning by turning existing “Level-1” problems into “Level-2” and “Level-3” problems, and compares a model's performance across multiple levels, including measuring causal reasoning through metrics like PN (Positive-Negative) Metric and PS (Positive-Specificity). This has the concrete benefit of improved scalability, in the ability to convert, automatically and at scale, simpler reasoning problems into more challenging ones.

Being able to assess reasoning skills in a fine-grained, specific, and more comprehensive way is an advantage in at least two ways.

The data generated by the synthesis pipeline is used in some embodiments as synthetic training data for model training, such as improving performance of an existing model on reasoning tasks via fine-tuning. Existing fine-tuning methods and infrastructure for large language models (e.g., fine-tuning interfaces provided on certain commercially available AI platforms) can be used for this purpose with synthetic data generated using the present techniques. The ability to generate the “synthetic data” test questions via the pipeline is a concrete improvement. Note the generation of synthetic data for training can be used independently of or in combination with the use of such data for testing/validation. For example, in one approach, different portions of a synthetic training data set generated using the described tools can be used for training (e.g. fine-tuning) and validation post-training respectively (e.g., using techniques such as Holdout Validation, K-Fold Cross-Validation, Leave-One-Out Cross-Validation etc. applied to synthetic data and ground truth generated using the described pipeline)

Moreover, tools for measuring the ability level of new language models to perform in various domains amount to a practical application in and of themselves. They are useful for scientific purposes, marketing, quality assurance, and engineering, for example. Reasoning skills in particular are hotly debated for each new model release, and generating more accurate assessments about the extent and limitations of those skills is an advantage for testing the robustness of models, making design decisions to improve these metrics, and making better decisions about what the technical applications such models can be used for.

Specific implementations will now be described in further detail by way of example only.

A framework for symbolic benchmark synthesis for reasoning evaluation is described.

As discussed, recent LLMs have reported high accuracy on reasoning benchmarks. However, it is still unclear whether the observed results arise from true “reasoning” or from statistical recall of the training set.

The present framework described herein characterizes a hierarchy of reasoning ability in LLMs, alongside an automated pipeline to generate problem variations across all the levels of the hierarchy. By altering problems in an intermediate symbolic representation, the present framework generates arbitrarily many problems that are not solvable using memorization alone. Moreover, the framework is general and can work across reasoning domains, including math, code, and logic. Types of insights that the present framework can generate are demonstrated. Several families of LLMs have been evaluated. A reduction in performance is observed when the models are queried with problem variations, suggesting a degree of reliance on statistical recall for past performance.

In comparison to the described framework, conventional manual approaches to generating new reasoning benchmark data are materially slower and more labor intensive, typically limited in practice to generating around a hundred or so reasoning problems.

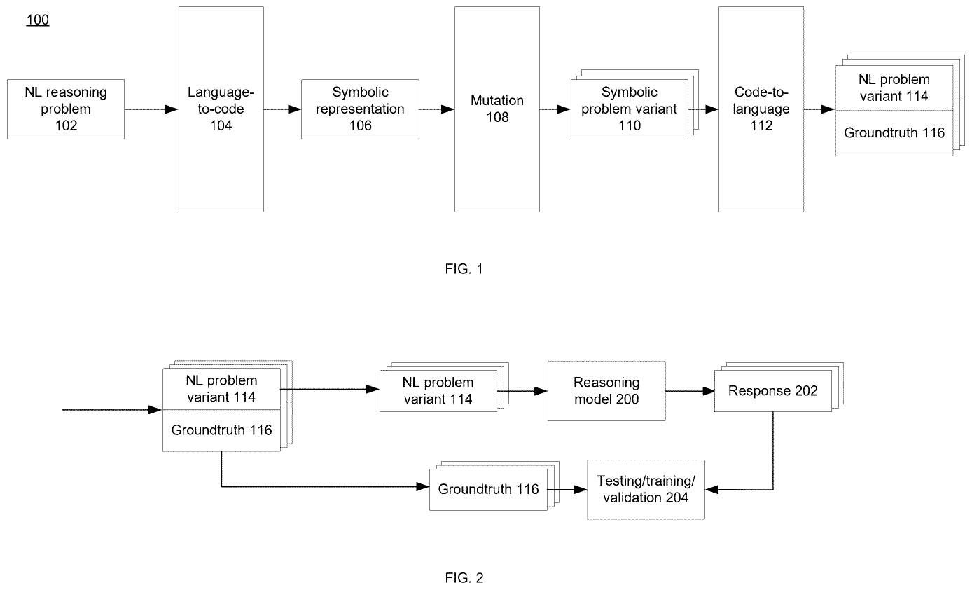

FIG. 1 shows a schematic block diagram of an example implementation of present framework in an automated reasoning data synthesis pipeline 100. The pipeline 100 is shown to comprise a language-to-code model 104 that receives a natural language (NL) reasoning problem 102 and converts the NL reasoning problem 102 into a symbolic representation 106. In other embodiments, a reasoning problem is initially formulated in a modality other than text (such as image or audio), in which case a suitable transformation from the input modality (e.g. image, audio etc.) to code is performed. For example, in some cases, an initial transformation to natural language is performed, followed by a transformation to code.

A “natural language reasoning question” means a text-based prompt expressing an underlying reasoning problem in natural language, designed to elicit one or more reasoning steps from a reasoning model. A “symbolic representation” means a structured form of the underlying reasoning problem expressed as variables and one or more relationships between the variables in a format suitable for programmatic manipulation and execution. This is used as an intermediate representation that is manipulated to generate additional variants programmatically in a highly scalable fashion.

A mutation component 108 receives the symbolic representation 106 and generates therefrom a mutation 110 of the symbolic representation 106, referred to he-rein as a “symbolic problem variant”. The term “mutating” in this context refers to a controlled transformation of the symbolic representation 106 that preserves its core logic while altering, e.g., one or more variables, structures, or statements to express (still in structured programmatic format) a different underlying reasoning problem. In other words, a mutation changes the baseline symbolic representation into a new instance while retaining essential logical aspects.

In the following examples, multiple symbolic problem variants are generated via different mutations of the same symbolic representation 106. A benefit of the described pipeline is its ability to generate multiple variants of the same reasoning problem, together with associated ground truth (see below). The following description refers to the symbolic problem variant 110 but applies equally to each symbolic problem variant generated via mutation of the symbolic representation 106

A code-to-language component 112 translates the generated symbolic problem variant 110 into natural language form (essentially the opposite of the language-to-code transformation applied at 104). The symbolic problem variant 110 is executable meaning it takes a form such as code or a computational graph that can be run programmatically to generate a corresponding ground truth response, which in the present context means a correct answer to the underlying reasoning problem variant it expresses. In other words, a “ground truth response” means a definitive correct output derived by executing the symbolic problem variant 110, serving as a reference answer, e.g. for the purpose of testing, validating or training a reasoning model (see below). A “natural language problem variant” means a reformulated version of the problem statement expressed in ordinary language, reflecting changes introduced via mutation of the symbolic representation.

Accordingly, the code-to-language component 112 generates from the symbolic problem variant 110 an output comprising a natural language problem variant 114 (expressing the same underlying reasoning problem variant but in natural language rather than symbolically), as well as its corresponding ground truth response 116.

Although described in relation to a single NL reasoning problem 102, the aforementioned operations can be applied to multiple problems, generating a symbolic representation of each problem and, in turn, generating one or more problem variants from each symbolic representation.

The intermediate executable symbolic representation 106 ensures that correct outcomes can be calculated automatically from the mutations. This approach generates a diverse set of “unseen” variations of existing, well-established benchmarks, providing novel challenges for LLMs.

The described framework contrasts with a conventional approach to evaluating reasoning in LLMs. In some examples, the NL reasoning problem 102 forms part of a known benchmark data set. Benchmarks across domains such as math, code, and logic can be systematically transformed using the principles of FIG. 1, generating challenging new scenarios that are unlikely to appear in the LLMs pre-training data. Findings indicate that all tested LLMs exhibit some degree of reliance on statistical recall, while problems at higher levels in a reasoning hierarchy remain a yet-unsolved challenge.

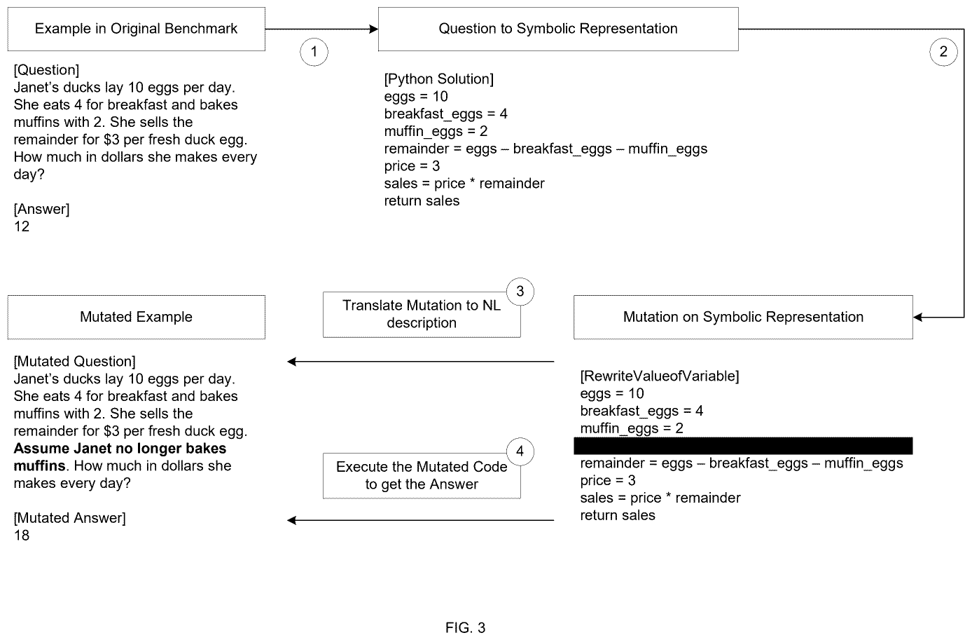

FIG. 2 shows a schematic block diagram of a pipeline, such as a testing, training or validation pipeline, that comprises a reasoning model 200 configured to receive one or more natural language (NL) problem variants 114 and to generate a response 202. A ground truth response 116 is employed to support testing, training, or validation 204 of the reasoning model 200.

The pipeline receives each NL problem variant 114 and compares the generated response 202 with the ground truth response 116.

In this example, each NL problem variant 114 is derived from a symbolic problem variant as per FIG. 1, while the ground truth response 116 provides a correct solution to the underlying reasoning problem. The pipeline thereby evaluates the reasoning model 200 by determining whether the response 202 aligns with the ground truth response 116 during testing, training, or validation 204.

The described approach enables the generation of multiple distinct NL problem variants 114 for comprehensive assessment of the reasoning model 200, with each variant accompanied by the ground truth response 116 as a definitive reference. By comparing the response 202 to the ground truth response 116, the pipeline tests the reasoning capabilities of the reasoning model 200 and (in some cases) selectively refines the reasoning model 200 to improve reasoning performance as measured in terms of accuracy of the response 202 relative to the ground truth response 116.

In the case of testing/validation, the reasoning model 200 is a trained model whose reasoning capabilities are being evaluated.

In some example use cases, the reasoning model 200 is both tested or validated using the synthetic reasoning data, and additional fine-tuned using such synthetic reasoning data. For example, in some such examples, a given mutation and associated ground truth is used both to test or validate the reasoning model 200 and to subsequently fine tune it. In other such examples, a first mutation and associated ground truth is used to test or validate the reasoning model 200 and a second mutation and associated ground truth is used in fine-tuning.

In the case of training, the reasoning model 200 is a model undergoing training, and whose reasoning capabilities are being tested as part of training. Note, the term “training” as used herein includes fine-tuning of an existing model. During training, parameters of the reasoning model 200 are tuned to optimize its reasoning performance, attempting to match the generated response 202 to the ground truth response 116 across a suitable training (e.g., fine-tuning) set.

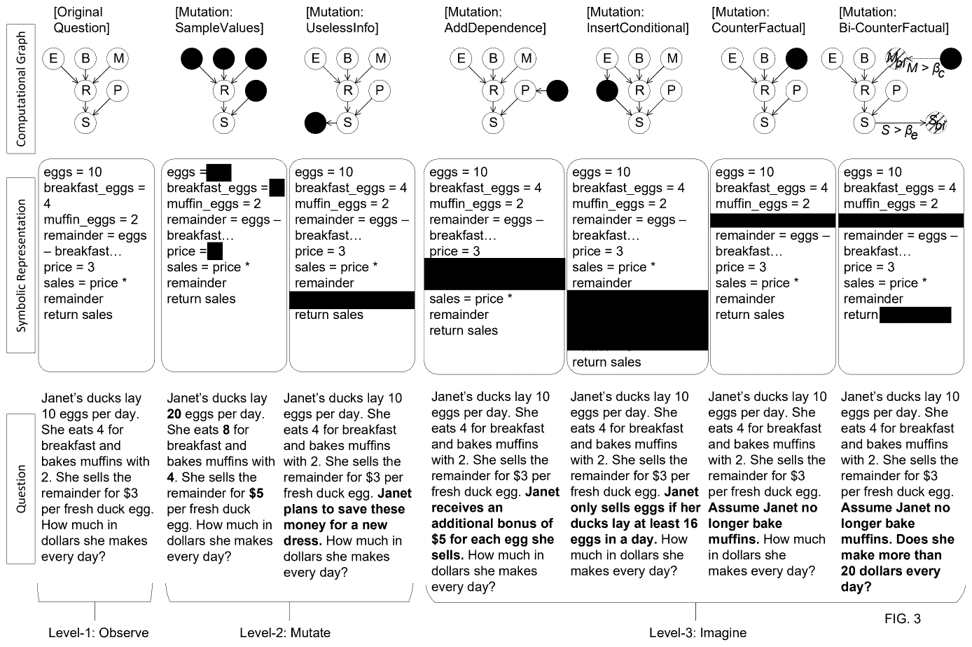

FIG. 3 shows further details of the mechanism described in FIG. 1 in one example implementation. The following description refers to FIG. 3 throughout. Additional contextual information is provided to assist understanding of FIG. 3 and the related description.

In FIG. 3, a benchmark transformation pipeline is depicted with an example from GSM8K. This pipeline leverages the symbolic representation of the question (a Python snippet) to automatically transform a math QA problem (leftmost) into a similar format with additional reasoning steps (rightmost). To clearly define the mutations (bottom), a symbolic representation is transformed into a computational graph (leftmost). Nodes represent variables from the symbolic representation, and edges illustrate dependencies between them. The remaining six graphs depict different types of mutations (see Section 3.2). E, B, M, R, P, and S represent variables eggs, breakfast_eggs, muffin_eggs, reminder, price, and sales, respectively. Grey shading highlights indicate the modifications made relative to the original versions. Nodes with dashed borders represent binary values, while nodes with solid borders are numeric.

A three-layer reasoning hierarchy (‘observe’, ‘mutate’, ‘imagine’) characterizes different levels of reasoning abilities in LLMs. This allows characterization and comparison of goals of different evaluation experiments with precision, both new and existing. A summary of the three levels is presented in Table 1.

TABLE 1

| | | | Evaluation |
|---|---|---|---|
| Level | Description | Examples | metric(s) |
| “1. | “Original | “Problems in | “Task |
| Observe” | problem.” | GSM8k, CLadder, | performance |
| | | CRUXEval Loop” | (original).” |
| “2. | “Mutated problem | “Replacing numeric | “Task |
| Mutate” | by replacing or | value, changing | performance |
| | adding | variable name, | (original and |
| | components” | modifying operator, | mutated).” |
| | | irrelevant | |
| | | information” | |
| “3. | “Original problem | “Extra logic | “Task |
| Imagine” | augmented with an | involving | performance |
| | ‘imagine’ statement, | revisions | (original and |
| | modifying the | or counterfactual | augmented) PN |
| | original statements | statements” | and PS (only in |
| | or assertions before | | counterfactuals).” |
| | it” | | |

Level-1 (“Observe”) captures the accuracy (or other metric of interest) of LLMs on existing benchmarks. It is called observe because it is expected that an LLM which has already seen training-set problems similar to the ones in the benchmark should be able to produce high accuracy.

Level-2 (“Mutate”) captures the ability of LLMs to solve problems that have been mutated by, for example, adding irrelevant information, renaming values, or changing values. It tests the ability of models to generalize beyond the existing benchmarks in cases where the core logical requirements of the questions are preserved. The results in such variations highlight memorization and over-fitting issues. For a true reasoning model, the task performance should be invariant with respect to the class of changes in this level.

Level-3 (“Imagine”) is the topmost and most sophisticated level. It captures the models' ability to correctly incorporate new information and logic into existing problems. Given a problem defined by a set of logical predicates or facts, this variation augments the original problem with an additional predicate that changes some previously stated one. Correctly incorporating new logic requires an accurate internal representation of the steps required to solve the problem, as well the ability to contradict and revise prior knowledge. Counterfactual assessments sit at this level of the hierarchy. Task performance metrics and counterfactual related metrics like the probability of necessity (PN) and sufficiency (PS) can be used in this level.

TABLE 2

| Benchmark | Type | Input | Output |
|---|---|---|---|
| GSM8K | Mathematics QA | NL math | Numerical |
| | | question | answer |
| CLadder | Causal QA | NL causal query | Y/N answer |

Table 2 contains a summary of existing natural language reasoning benchmarks, on which the steps of FIG. 3 can be applied to generate new problem variants.

Referring to FIG. 3, Steps 1 and 3 correspond to transformations from NL to Symbolic and Symbolic to NL respectively. Beneficially, these steps allow benchmarks problems to be accommodated even when that have original problems not already in code form. In practice, some level of adaptation to the nature of the benchmark is beneficial in some contexts. Details for these steps are provided below.

Six code mutations spanning the Level-2 and Level-3 reasoning levels are considered by way of example to create benchmark variations. To thoroughly define the mutations in 2, the pipeline 100 converts the symbolic representation into a computational graph (leftmost column in the bottom row of FIG. 3). Nodes represent variables in the symbolic representation and edges capture their dependencies. The mutation applied to the computational graph is then reflected in the symbolic representation and translated into NL. The remaining six columns in FIG. 3 illustrate mutation variations.

The following Level-2 mutations are considered by way of example.

A “Sample Values” mutation assigns new values to all root nodes. When translating the mutation back to NL, only the values in the question are replaced with the new ones, while the rest of the narration remains unchanged. This mutation specifically aims to differentiate the model's reasoning ability from memorization caused by data contamination.

A “Useless Info” mutation adds a new node dependent on a randomly selected node from the original graph, with the change described in NL between the context and the question. This introduces additional context, but does not alter original statements or impact the correct answer. This assesses the model's ability to disregard irrelevant information.

The following Level-3 mutations are considered by way of example.

An “Add Dependence” mutation introduces a new node into the graph. However, unlike Useless Info, a randomly selected node from the original graph is modified to depend on the new node for its calculation. This is likely to influence the correct answer to the question. A natural way to encode this mutation in NL is to append a statement to the end of the original question, amending the original statement context, making this a Level-3 mutation.

An “Insert Conditional” mutation adds a new node that connects two non-adjacent nodes in the graph, with edges linking the first node to the new node and the new node to the second node. In symbolic terms, this mutation is represented as an if-else condition. Two variables are randomly chosen, and one variable's value is set to 0 depending on the value of the other. Describing this in NL as a change to the previous method of calculating the variable, it also becomes a Level-3 mutation.

A “Counterfactual” mutation randomly selects a node in the graph and overwrites its value. Unlike Sample Values, this mutation does not directly replace the number in the question. Instead, it presents the change as an assumption statement appended to the original question. Thus, it modifies an existing statement in the context and adds an extra reasoning step to the original question—a Level-3 mutation.

A “Bi-Counterfactual” mutation builds on Counterfactual to evaluate the model's ability to connect the presence or absence of a cause with its effect, an essential reasoning skill from the perspective of causation. Conventional approaches quantitatively evaluate this through necessity and sufficiency inconsistency rates (N-IR and S-IR), but rely on manually crafted questions and their counterfactuals. In contrast, the present automated pipeline unlocks large-scale analysis. In Bi-Counterfactual, the computational graph is treated as a Structural Causal Model (SCM), where the overwritten node acts as the cause and the final answer (leaf node) serves as the effect. Specifically, Bi-Counterfactual requires binary cause and effect nodes, with the overwritten value ensuring a change in the cause statement's presence or absence.

Returning to FIG. 3, in more detail, a multi-stage pipeline for transforming a natural language reasoning problem into a mutated variant is shown, illustrating how an initial symbolic representation is mutated to produce both a symbolic problem variant and a natural language problem variant. The pipeline includes a question input, a symbolic representation, a mutation step, and a translation to a mutated example for further analysis, ensuring consistent alignment between the symbolic modifications and the textual output. The top region depicts an input question specifying a daily routine: a certain number of eggs, a breakfast portion, a remainder sold for a price, and a resulting daily income. The pipeline converts this question into a Python-style symbolic representation, where each variable-eggs, breakfast_eggs, muffin_eggs, remainder, price, and sales—is captured as a node. A directed edge from one node to another conveys how a value is derived or used. For instance, eggs minus breakfast_eggs yields the remainder, which multiplies by price to produce sales. Multiple mutation types are illustrated, including a rewrite of a variable's value, an insertion of an extra dependency, a conditional instruction, a counterfactual modifying a past assumption, and a bi-counterfactual combining multiple alterations. These mutations appear as updates to variable nodes or as newly introduced nodes labeled with letter placeholders such as “X”. A user can adjust these variables to reflect changes in how the question is posed, enabling flexible transformations. Each updated node value is reflected in a newly generated graph that feeds into a revised natural language prompt.

Grey shading in FIG. 3 distinguishes altered text, such as a raised egg count or substituted muffin operation. One section exemplifies insertion of a bonus for each egg; another shows a conditional branch where sales is reset if the egg count exceeds a threshold. The final row shows how each mutation is translated into a mutated natural language statement and a new answer. Nodes with a dashed border represent binary states, while all unchanged nodes are numerical. Relabeled edges and textual labels together enable an observer to trace precisely which aspects of the original question were altered and how those changes propagate through the symbolic graph, culminating in an augmented or modified result suitable for further analysis.

As discussed, the pipeline can be applied to existing natural language benchmarks to programmatically generate new reasoning problem variants and ground truth at scale. Two such benchmarks—Cladder and GSM8K—are considered purely for the purposes of illustration.

The pipeline 100 begins by taking original question-and-answer pairs and modifying the prompt text through carefully designed transformations. These transformations introduce new statements, change variable names, or insert extra conditions. Some mutate numeric values, while others embed extraneous or counterfactual elements. Each approach ensures that the essential logical structure of the question is altered without changing its broader context.

Additional transformations rely on in-context examples. The system may provide both original and mutated examples, or only mutated examples, or only original examples, to investigate how altered prompts affect consistency. New lines or details can be appended, with instructions to keep the final question aligned with the original's structure. A chain of reasoning in the examples is similarly adjusted.

For CLadder, the pipeline 100 filters out particular queries and then translates valid ones into executable Python code. The system confirms correctness by comparing the computed result to a known reference. The mutations add extra information or a counterfactual assumption that modifies parameters in the probability distributions. The text prompt and the corresponding code are both updated to reflect the new scenario while retaining the initial reasoning procedure.

For GSM8K, the pipeline 100 modifies the original numeric question-and-answer pairs by adding unrelated statements, adjusting numeric values, or introducing conditional elements. Each mutated question remains aligned to the original structure but includes distractors or altered parameters. Sometimes multiple mutations are combined, such as by adding extraneous text alongside another alteration. The system also tests how using original versus mutated in-context examples affects solution consistency. Throughout, the chain of reasoning is updated to reflect newly introduced conditions while preserving the essential logic.

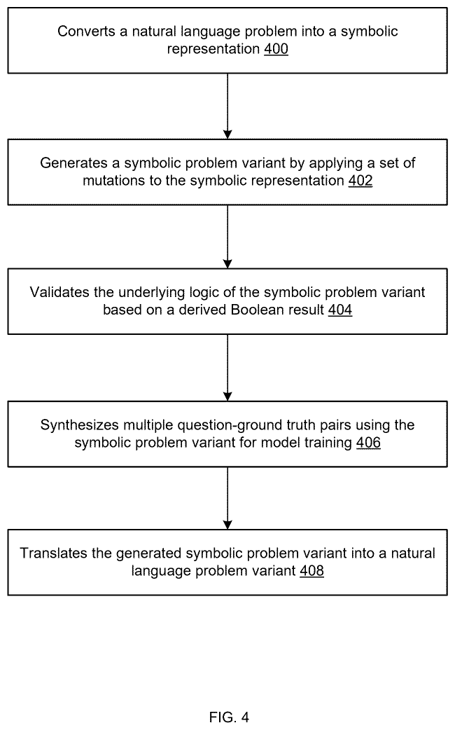

FIG. 4 shows a flowchart for a method of synthesizing reasoning problem variants from one or more existing natural language reasoning problems.

At step 400, the method converts a natural language problem into a symbolic representation capturing key variables and dependencies, such as the symbolic representation 106 of FIG. 1.

At step 402, the method introduces a controlled mutation 108 to create a symbolic problem variant 110, implementing the approach discussed in earlier FIGS.

At step 404, the method validates the mutated representation, for example by deriving a Boolean or numeric check to confirm logical coherence, using the techniques described above with reference to FIG. 3.

At step 406, the method automatically generates one or more question-ground truth pairs from the symbolic problem variant, providing fresh data for training or evaluation, using the mechanisms described in detail above with reference to FIGS. 1 and 3.

At step 408, the method the generated symbolic problem variant into a natural language problem variant and, in some cases, associated ground truth suitable for reasoning model testing, validation and/or training.

### Example: GSM8K

Further details of a benchmark transformation process is described by way of example with reference to GSM8K. The transformation and a quality evaluation quality are described.

GSM8K results summary: model accuracy on numerical answer predictions across test set variations in different reasoning levels.

Question to Symbolic Representation: OpenMathInstruct is a known dataset, whose validation set contains 970 GSM8K QA examples paired with Python solutions generated by Mixtral-8x7B. In the present context, a test set is generated by filtering out examples where Python solution execution does not match the ground-truth answers. To ensure high-quality mutations, the data is further filtered to keep only those where all constant variables in the code (root nodes in the computational graph) align with the numbers in the question and vice versa.

Symbolic Representation to Mutation: any of the six types of mutation described above can be used. Since most GSM8K questions are framed within a story context, it is ensured that newly sampled values for existing variables align with the original value's type (float/integer) and sign to preserve the story's coherence. Within this constraint, integers are sampled from a discrete uniform distribution, while floats are drawn from a uniform distribution centered around the original value. It is also ensured that the final answer maintains the same type and sign as the original.

Mutated Symbolic to NL: In the Sample Values mutation, only the values in the questions are replaced with newly sampled ones, while the rest of the narrative stays the same, so no new NL descriptions are required. For the other mutation types, the original math question, its Python solution, and the code modifications to a language model, e.g. (LLM such as GPT-40), leveraging its text generation capabilities to describe the code changes in natural language. To guarantee the symbolic-to-NL translation is correct, the language model is prompted a second time to back-translate the mutated math problem into Python by modifying the original question's Python solution. The generated code must produce an execution result that matches the ground truth answer of the mutated question.

To verify the accuracy of the mutated QA pairs, a selection of randomly selected examples from each mutation type is also manually reviewed. Valid examples are ones that contain a clearly defined question and a correct ground-truth answer.

Reasoning on Numerical Math QA: During testing, in some implementations, all models are provided with one or more in-context examples with Chain-of-Thought (CoT) to help them understand the task.

Reasoning Evaluation with Binary Counterfactuals: Bi-Counterfactual as described above creates two auxiliary nodes in the computation graph with binary versions of a condition and an outcome. The reason for considering this problem transformation is that it enables computation of metrics that are relevant to evaluate reasoning beyond accuracy. This scenario enables the computation of a probabilities of necessity (PN) and sufficiency (PS). These measures capture the probability of activating/deactivating a binary outcome in the presence/absence of a binary input.

### Example: CLadder

The CLadder dataset provides a systematic evaluation of causal reasoning abilities in LLMs. It comprises 10,000 causal graphs of binary variables (Bernoulli conditional distributions) that encompass common treatment-effect estimation scenarios, such as confounding, mediation, and collisions. Each causal graph is associated with multiple queries, spanning the three levels of Pearl's ladder of causation: associational, interventional, and counterfactual. Each dataset example includes (1) a causal graph, (2) a query, (3) a causal engine that computes over the casual graph and the query to get a binary answer, and (4) a template-based formulation that translates the causal graph and the query into a natural language question for the LLM to interface with. The benchmark evaluates models' causal reasoning abilities by requiring them to (1) extract causal concepts from natural language and (2) apply causal inference (either implicitly or explicitly) over the causal concepts, such as do-calculus, to calculate the final answer.

Extensions of the question to symbolic representation (language-to-code) part of the pipeline are described below.

Filtering: a filtering pass of 10,000 examples in Cladder removes all examples corresponding to query types ‘backdoor adjustment’ and ‘collider bias’ (in total 1,747 examples). The former was filtered due to the inherent complexity of code (e.g. Python) it would require, and the latter because it is only present for one type of causal graph structure.

Parser: a parser automatically translates these examples into Python code assisted by a causal engine provided by CLadder. The parser determines a query type from meta data in the CLadder examples, and extracts relevant variables from the natural language questions. For every query type, causal graph, and estimand, the parser generates a snippet of executable Python code which computes the estimand.

Validation: To verify success or failure of language-to-code execution, after conversion of the examples, the pipeline executes the Python code and compares the computed estimand value with its ground-truth in CLadder. Each example whose result as computed via code execution does not match its ground-truth is filtered-out.

Examples of machine learning (ML) reasoning model architectures to which the described validation and related downstream methods (including training, fine tuning, synthetic data generation to support training, fine-tuning and other data-driven tasks) can be applied include GPT-01, GPT-01-mini, GPT-03, GPT-03-mini and DeepSeek.

A trained ML model has many practical applications in various fields of technology. One or more tasks can include automatic code analysis that is executed on a hardware processor to perform a technical activity, such as a form of image or audio processing or one or more industrial process controls. By strengthening a model's reasoning capacity, tangible improvements in synthesized code can be realized, in turn enhancing an expanding set of technical applications. This covers everything from specialized real-time data pipelines to higher-level orchestrations of industrial robotics, each harnessing reasoned code generation for reliability and precision. In certain deployments, the synergy between reasoned code generation and hardware-based implementation fosters robust solutions in tasks like anomaly detection, sensor fusion, or advanced calibrations. Because a single well-trained model can adapt to multiple domains, any incremental gain in reasoning capabilities may yield improvements across a broad range of use cases, from embedded devices to large-scale networked infrastructures.

For example, a trained reasoning model could be configured either as a declarative network, used for classification or regression tasks, or as a generative network, which can synthesize new data points. Applications span image classification or extraction of meaningful information from images, text classification, or analyzing audio signals to distinguish speech from non-speech. Similar modeling approaches can be extended to sensor data, enabling tasks such as automated measurement, machine control, or medical diagnostics. In all these scenarios, the model's refined reasoning ability can yield significant accuracy improvements and robust performance by facilitating more consistent intermediate inferences.

Any of the aforementioned or related applications may be improved in terms of accuracy, precision, or reliability when supported by one or more trained ML models. In some configurations, this includes generating a technical output in cybersecurity, such as identifying anomalous or suspicious data points, taking remediation measures, or synthesizing data to train and validate other security components. Another notable application is generating an industrial output, for instance controlling a manufacturing machine. Advanced engineering contexts include diagnosing system faults or designing technical systems. System optimization is another example, encompassing the detection and mitigation of runtime performance problems or efficient use of resources in hardware and software deployments. Because each domain may demand consistent intermediate inferences, a reasoning-based model helps sustain robust performance under diverse operating conditions.

In addition, certain technical scenarios benefit from improved scalability in high-performance computing (HPC) contexts, where a model's advanced reasoning can guide resource management, balancing tasks across clusters or devices. Through iterative validation on newly generated synthetic tasks, one or more refined models can adapt to broader workloads without breaking reliability constraints. Such approaches enable embedded devices and large-scale systems alike to leverage a more adaptive, domain-aware solution that surpasses mere pattern matching. By systematically refining model performance with evidence from varied tasks, developers can help ensure that HPC pipelines fully harness the benefits of robust, reasoned code generation.

As further examples, techniques described may be applied to train one or more ML models that control technical systems or processes, such as an X-ray apparatus, a steel cooling process, a compaction machine that must make a required number of passes to achieve a specified density, or digital audio, image, or video enhancement tasks. These approaches support activities like de-noising, localizing persons in digital images, or estimating quality of transmitted signals. Additional uses include speech recognition or audio source separation, reliable data encoding for transmission or storage, optimizing load distribution in a computing network, or monitoring physiologic data from sensors. One or more models may generate confidence intervals for genotype estimates or facilitate automated medical diagnostics. They can also assess signals from a heart monitoring apparatus to classify irregular beats or analyze digital media based on low-level features. All such methods rely on a trained model's capacity to interpret or generate data beyond trivial memorization.

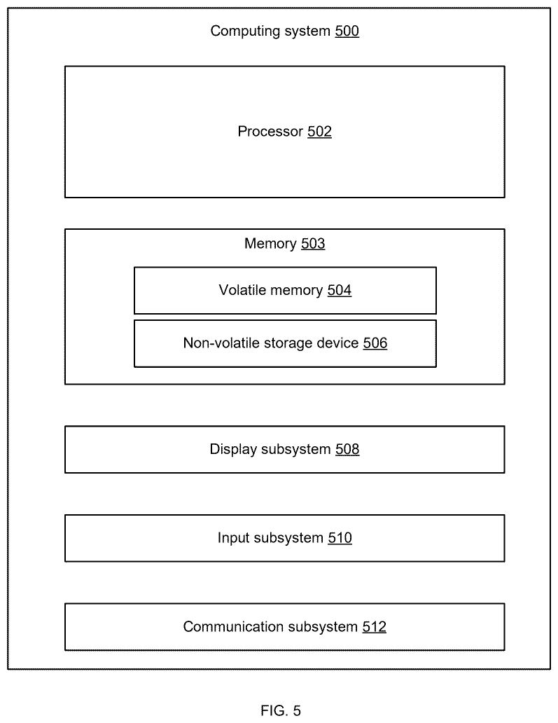

FIG. 5 schematically shows an example of a computer system 100, such as a computing device or a connected system of computing devices configured in various ways to implement any of the methods described. A computer system 100 is shown in simplified form and comprises a processor 502 (such as a CPU, GPU, TPU or other accelerator processor or any combination thereof) and a memory 103. In this example, the memory 103 is shown to include a volatile memory 504 and a non-volatile storage 506. In this example, the computer system 100 includes a display subsystem 508, an input subsystem 510, and a communication subsystem 512. In other examples, one, some, or all of subsystems 508, 510, 512 may be omitted. The processor 502 comprises one or more hardware processing units, which may be programmable or non-programmable and may execute computer-readable instructions based on an instruction set. Examples include central processing units, graphics units, tensor units, neural processors, or field-programmable gate arrays. Some may be integrated into a single device, and others may be distributed among multiple devices cooperating over distance. The memory 103 includes computer-readable media in the form of the volatile memory 504 for short-term data and instruction storage and the non-volatile storage 506 for longer-term storage. Non-volatile technology can include optical or magnetic media, solid-state storage, or any other data store. The display subsystem 508 may present graphical output, and the input subsystem 510 may include user input devices such as keyboards, mice, or touchscreen interfaces. The communication subsystem 512 may provide wired or wireless links for exchanging data over one or more networks. References to a module or engine refer to particular functionalities implemented as hardware or software in the computer system 100, which may include separate or overlapping sets of code, objects, or libraries.

A processor 502 typically utilizes the volatile memory 504 for short-term data storage during active execution, while the non-volatile storage 506 permanently or semi-permanently maintains data and instructions. In certain embodiments, a software module, program, or engine is implemented by executing instructions from the non-volatile storage 506 by the processor 502, leveraging the volatile memory 504 for runtime data. The display subsystem 508 can render graphical interfaces, and it may be integrated physically with the system or be peripheral. The input subsystem 510 processes input from a variety of sensors or interfaces, including natural user input components like microphones for speech recognition. The communication subsystem 512 can connect the system 100 to external devices or networks. Computer-readable media includes the volatile memory 504 and the non-volatile storage 506 but not signals in transit (e.g., carrier waves), whereas communication media encompass data structures, program modules, or other data in a modulated signal for information delivery.

In a first aspect, there is provided a computer-implemented method, comprising: generating, based on a reasoning problem, a symbolic representation of the reasoning problem, the symbolic representation comprising a first variable, a second variable and a dependency between the first variable and the second variable; generating a mutation of the symbolic representation, resulting in a symbolic problem variant; generating, based on the symbolic problem variant, a reasoning problem variant; and testing, using the reasoning problem variant, reasoning capability of a reasoning model.

In embodiments, a reasoning model is used to perform: automatic code analysis or synthesis, industrial process control, sensor data processing, cybersecurity analysis, system fault diagnosis, technical system design or optimization, computer hardware or software resource management, industrial machine control, a medical diagnostic, audio processing, image processing, signal processing, synthetic image, audio or sensor data generation, anomaly detection, sensor fusion.

In embodiments, the symbolic problem variant is executable, and execution of the symbolic problem variant yields a ground truth response for the reasoning problem variant, wherein the reasoning capability of the reasoning model is tested using the reasoning problem variant and the ground truth response.

In embodiments, the symbolic problem variant is formed of executable code.

In embodiments, the symbolic problem variant is formed of an executable knowledge graph or computational graph.

In embodiments, the method comprises fine-tuning the reasoning model using the reasoning problem variant and the ground truth response.

In embodiments, the method further comprises generating a second mutation of the symbolic representation, resulting in a second symbolic problem variant; generating, based on the second symbolic problem variant, a second reasoning problem variant; and executing the second symbolic problem variant, resulting in a second ground truth response for the second reasoning problem variant.

In embodiments, the method comprises fine-tuning the reasoning model using the second reasoning problem variant and the second ground truth response.

In embodiments, the method comprises transforming the symbolic representation, resulting in a computational graph comprising a first node representing the first variable, a second node representing the second variable, and an edge between the first node and the second node capturing the dependency between the first variable and the second variable, wherein generating the mutation comprises mutating the computational graph, resulting in the symbolic problem variant.

In embodiments, the symbolic problem variant is one of multiple symbolic problem variants generated from the symbolic representation, each of which is used to generate a reasoning problem variant.

In embodiments, generating the mutation comprises: modifying the first variable or the second variable, modifying the dependency, adding a third variable, adding a second dependency, or adding a third variable and a second dependency between the third variable and the first variable or the second variable.

In embodiments, the reasoning problem and the reasoning problem variant are each expressed in natural language.

In a second aspect, there is provided a computer-implemented method, comprising: generating, based on a reasoning problem, a symbolic representation of the reasoning problem, the symbolic representation comprising a first variable, a second variable and a dependency between the first variable and the second variable; generating a mutation of the symbolic representation, resulting in a symbolic problem variant; generating, based on the symbolic problem variant, a reasoning problem variant and a ground truth response for the reasoning problem variant; and training a reasoning model using the reasoning problem variant and the ground truth response, resulting in a trained reasoning model.

In embodiments, the method comprises performing, using the trained reasoning model, automatic code analysis or synthesis, industrial process control, sensor data processing, cybersecurity analysis, system fault diagnosis, technical system design or optimization, computer hardware or software resource management, industrial machine control, a medical diagnostic, audio processing, image processing, signal processing, synthetic image, audio or sensor data generation, anomaly detection, sensor fusion.

In embodiments, the symbolic problem variant is executable, the method comprising executing the symbolic problem variant, resulting in the ground truth response for the reasoning problem variant.

In embodiments, the method further comprises generating a second mutation of the symbolic representation, resulting in a second symbolic problem variant; generating, based on the second symbolic problem variant, a second reasoning problem variant; and generating a second ground truth response for the second reasoning problem variant.

In embodiments, the reasoning model is trained using the second reasoning problem variant and the second ground truth response.

In embodiments, the method comprises testing or validating the reasoning model using the second reasoning problem variant and the second ground truth response.

In embodiments, the method comprises testing or validating the reasoning model using the reasoning problem variant and the ground truth response.

A further aspect herein provides a computer-implemented method, comprising generating, based on a natural language reasoning question, a computational graph encoding the reasoning problem, the computational graph comprising a first variable node, a second variable node and a dependency edge between the first variable node and the second variable node; generating a mutation of the computational graph, resulting in a mutated computational graph; generating based on the mutated computational graph a natural language problem variant; and testing, using the natural language problem variant, reasoning capability of a reasoning model.

In a third aspect, there is provided a computer system comprising a memory embodying executable instructions and a processor configured to execute those instructions, which upon execution cause the processor to implement any of the aforementioned aspects or embodiments.

In a fourth aspect, there is provided a computer-readable storage medium embodying executable instructions which, upon execution by a processor, cause the processor to implement any of the aforementioned embodiments.

Examples described above are illustrative. Further variations are envisaged. Any feature described in relation to one example may be used alone or combined with others. Equivalents or modifications not explicitly described may also be employed for practical implementations.

1. A computer-implemented method, comprising:
generating, based on a reasoning problem, a symbolic representation of the reasoning problem, the symbolic representation comprising a first variable, a second variable and a dependency between the first variable and the second variable;
generating a mutation of the symbolic representation, resulting in a symbolic problem variant;
generating based on the symbolic problem variant a reasoning problem variant; and
testing, using the reasoning problem variant, reasoning capability of a reasoning model.

2. The method of claim 1, wherein the reasoning model is used to perform:
automatic code analysis or synthesis,
industrial process control,
sensor data processing,
cybersecurity analysis,
system fault diagnosis,
technical system design or optimization,
computer hardware or software resource management,
industrial machine control,
a medical diagnostic,
audio processing,
image processing,
signal processing,
synthetic image, audio or sensor data generation,
anomaly detection, or
sensor fusion.

3. The method of claim 1, wherein the symbolic problem variant is executable, the method comprising executing the symbolic problem variant, resulting in a ground truth response for the reasoning problem variant, wherein the reasoning capability of the reasoning model is tested using the reasoning problem variant and the ground truth response.

4. The method of claim 3, wherein the symbolic problem variant is formed of executable code.

5. The method of claim 3, wherein the symbolic problem variant is formed of an executable knowledge graph or computational graph.

6. The method of claim 3, comprising fine-tuning the reasoning model using the reasoning problem variant and the ground truth response.

7. The method of claim 1, comprising:
generating a second mutation of the symbolic representation, resulting in a second symbolic problem variant;
generating based on the second symbolic problem variant a second reasoning problem variant;
executing the second symbolic problem variant, resulting in a second ground truth response for the second reasoning problem variant.

8. The method of claim 7, comprising fine-tuning the reasoning model using the second reasoning problem variant and the second ground truth response.

9. The method of claim 1, transforming the symbolic representation, resulting in a computational graph comprising a first node representing the first variable, a second node representing the second variable, and an edge between the first node and the second node capturing the dependency between the first variable and the second variable, wherein generating the mutation comprises mutating the computational graph, resulting in the symbolic problem variant.

10. The method of claim 1, wherein the symbolic problem variant is one of multiple symbolic problem variants generated from the symbolic representation, each of which is used to generate a reasoning problem variant.

11. The method of claim 1, wherein generating the mutation comprises:
modifying the first variable or the second variable,
modifying the dependency,
adding a third variable,
adding a second dependency, or
adding a third variable and a second dependency between the third variable and the first variable or the second variable.

12. The method of claim 1, wherein the reasoning problem and the reasoning problem variant are each expressed in natural language.

13. A computer system, comprising:
a memory embodying executable instructions; and
a processor coupled to the memory, and configured to execute the executable instructions, which upon execution cause the processor to perform operations of:
generating, based on a reasoning problem, a symbolic representation of the reasoning problem, the symbolic representation comprising a first variable, a second variable and a dependency between the first variable and the second variable,
generating a mutation of the symbolic representation, resulting in a symbolic problem variant,
generating based on the symbolic problem variant: a reasoning problem variant, and a ground truth response for the reasoning problem variant, and
training a reasoning model, using the reasoning problem variant and the ground truth response, resulting in a trained reasoning model.

14. The computer system of claim 13, comprising performing using the trained reasoning model:
automatic code analysis or synthesis,
industrial process control,
sensor data processing,
cybersecurity analysis,
system fault diagnosis,
technical system design or optimization,
computer hardware or software resource management,
industrial machine control,
a medical diagnostic,
audio processing,
image processing,
signal processing,
synthetic image, audio or sensor data generation,
anomaly detection, or
sensor fusion.

15. The computer system of claim 13, wherein the symbolic problem variant is executable, the method comprising executing the symbolic problem variant, resulting in the ground truth response for the reasoning problem variant.

16. The computer system of claim 13, said operations comprising:
generating a second mutation of the symbolic representation, resulting in a second symbolic problem variant;
generating based on the second symbolic problem variant: a second reasoning problem variant, and a second ground truth response for the second reasoning problem variant.

17. The computer system of claim 16, wherein the reasoning model is trained using the second reasoning problem variant and the second ground truth response.

18. The computer system of claim 16, comprising testing or validating the reasoning model using:
the second reasoning problem variant and the second ground truth response, or the reasoning problem variant and the ground truth response.

19. A computer-readable storage medium embodying executable instructions, which upon execution by a processor cause the processor to perform operations of:
generating, based on a reasoning problem, a computational graph encoding the reasoning problem, the computational graph comprising a first variable node, a second variable node and a dependency edge between the first variable node and the second variable node;
generating a mutation of the computational graph, resulting in a mutated computational graph;
generating based on the mutated computational graph a reasoning problem variant; and
testing, using the reasoning problem variant, reasoning capability of a reasoning model.

20. The computer-readable storage medium of claim 19, wherein the operations comprising performing using the reasoning model:
automatic code analysis or synthesis,
industrial process control,
sensor data processing,
cybersecurity analysis,
system fault diagnosis,
technical system design or optimization,
computer hardware or software resource management,
industrial machine control,
a medical diagnostic,
audio processing,
image processing,
signal processing,
synthetic image, audio or sensor data generation,
anomaly detection, or
sensor fusion.
